(19) United States
(12) Patent Application Publication
(10) Pub. No.: US 2005/0118345 A1
(43) Pub. Date: Jun. 2, 2005

(54) Paint edger

(76) Inventor: James Burghoffer, Denville, NJ (US)

Correspondence Address: WEINGRAM & ASSOCIATES P.C., P.O. BOX 927, MAYWOOD, NJ, 07607, US

(21) Appl. No.: 10/781,054

(22) Filed: Feb. 18, 2004

Related U.S. Application Data
(60) Provisional application No. 60/526,125, filed on Dec. 1, 2003.

(51) Int. Cl. B05C 17/00

(52) U.S. Cl. 427/429; 15/210.1

(57) ABSTRACT

A paint edger and a method of applying a surface coating to one or both of two intersecting surfaces without applying paint to the corresponding surface are disclosed. The applicator pads may be separated so that each may be used simultaneously and independently of the other to apply a different color paint at the same time to each of two intersecting surfaces. One or more applicator pads coact with a separator guide blade to enable applying different surface coatings to intersecting surfaces.

### BACKGROUND

1. Field of the Invention

The present invention relates to paint applicators used for applying paint at intersecting surfaces such as internal corners, or any other circumstance where two surfaces intersect.

2. Description of the Related Art

In the painting operation, the most difficult and time consuming task is the process of edging, namely the process of applying paint to one of two intersecting surfaces without applying paint to the corresponding surface. This can occur when either one of the intersecting surfaces is painted or both of the intersecting surfaces are painted.

There are many devices which attempt to provide a means for placing paint on one surface without having any of the paint contact the intersecting surface. However, none of the prior art devices have been successful in providing an apparatus which can apply paint to two intersecting surfaces simultaneously while maintaining the separation of the paints on the separate intersecting surfaces.

Numerous references describe paint edgers. However, none of these references teach or suggest the specific novel paint edger of the invention.

U.S. Pat. No. 5,933,905 to Hess discloses a paint trimming apparatus having a mounting plate having a front edge, a handle, a planar guide having a guide edge, and a guide support coupled to the mounting plate. The guide support pivotably couples the guide to the guide support to position the guide edge to overlie the front edge and position the guide between the loading position and the paint trimming position.

U.S. Pat. No. 5,432,972 to Polzin et al. discloses a corner painting tool including a one-piece paint pad hinged longitudinally so that the contour of the pad may be changed from concave to flat to convex, enabling the paint pad to paint exterior corners, flat surfaces and interior corners. An inverted U-shaped handle is mounted to the opposing side edges of the paint pad. The user presses the handpieces to flex the one-piece pad to cause it to conform to the surface being painted.

U.S. Pat. No. 5,293,662 to Newman, Sr. et al. discloses a corner paint pad assembly having two pads. However, there is no provision for separating the pads so that each can be used simultaneously and independently of the other to apply two different color paints at the same time to two different surfaces.

U.S. Pat. No. 5,267,369 to O'Neil et al. discloses a corner painting tool having a pad whose contour may be changed by hand pressure on the applicator during painting.

U.S. Pat. No. 5,134,745 to Burns et al. discloses a paint trimming device having a single paint pad and an edger in the form of a plate extending along the front edge of the base of the device, the edger having downwardly projecting runner means which enable paint carried by the paint pad to be placed up to but not beyond a certain point.

U.S. Pat. No. 4,852,203 to LaBelle discloses a paint edger comprising a holder with a quick-remove pad.

U.S. Pat. No. 3,981,595 to Blake discloses a dispensing paint trimmer including a pair of guides positioned at right angles and a dispensing gun using a cartridge for painting one of two intersecting walls.

However, among the foregoing patents, none disclose or suggest the specific edge painter of the invention. The present application sets forth an apparatus comprising a frame having movable plates mounted to the frame which plates normally repose at right angles to each other and which are separated by a separator guide blade. Each of the plates mounts a separate applicator pad for paint which applicator pad can be swung away from the frame to enable application of paint to one surface without fear of contaminating the surface of the other pad, which can have the same or a different color of paint applied to it. The separator guide blade maintains the separation of the applicator pads but allows close proximity. The guide blade is resiliently self-positioning to locate the intersection of the adjacent intersecting surfaces to maintain the proper positioning of the applicator pads as they are drawn along the intersecting surfaces.

### OBJECTS AND SUMMARY OF THE INVENTION

Accordingly, it is an object of the present invention to provide a durable edging apparatus for applying paints to intersecting surfaces which is simple to use.

It is a further object of the present invention to provide an edging apparatus for applying paints to intersecting surfaces which is easy to use.

It is yet another object of the present invention to provide an edging apparatus for applying paints to intersecting surfaces which can edge two opposing surfaces using two different color paint.

Another object of the present invention to provide an edging apparatus for applying paints to intersecting surfaces which can paint two opposing surfaces simultaneously using different colors.

Yet another object of the present invention to provide an edging apparatus for applying paints to intersecting surfaces which contain one of two surfaces at the discretion of the operator.

A further object of the present invention to provide an edging apparatus for applying paints to intersecting surfaces which has paint applicator pads which are easy to change.

It is an object of the present invention to provide an edging apparatus for applying paints to intersecting surfaces which apparatus is easy to clean.

It is an object of the present invention to provide an edging apparatus for applying paints to intersecting surfaces which prevents running, dripping, or smearing of one color to the other color being applied.

It is an object of the present invention to provide an edging apparatus for applying paints to intersecting surfaces which has a separator guide spring that prevents contamination of one surface to the intersecting surface.

It is an object of the present invention to provide an edging apparatus for applying paints to intersecting surfaces which has a spring guide that insures proper alignment of the applicator pads to the paint path.

It is an object of the present invention to provide an edging apparatus for applying paints to intersecting surfaces which allows for separate application of paint to separate applicator pads.

It is an object of the present invention to provide an edging apparatus for applying paints to intersecting surfaces which has movable pads that allow for spacing of pads during loading of paint to prevent contamination or mixing of colors.

It is an object of the present invention to provide an edging apparatus for applying paints to intersecting surfaces which has movable pads that allow application of paint removed from the painting position of the apparatus which handle is positioned to allow application of paint and loading of pads without contacting the user's hands.

It is an object of the present invention to provide an edging apparatus for applying paints to intersecting surfaces which allows for application of paint to the applicator pads using a single hand.

It is an object of the present invention to provide an edging apparatus for applying paints to intersecting surfaces which provides for mounting applicator pads so as the pads are easily replaceable without the applicator surface contacting the tool.

These, and various other and further features and advantages of the invention will become apparent from the following detailed description, taken in conjunction with the accompanying drawings, which illustrate by way of example the principles of the invention.

### BRIEF DESCRIPTION OF THE DRAWINGS

FIG. 1 is a perspective view taken from the top rear of the paint edger of the present invention in closed position.

FIG. 2 is a perspective view taken from the top front of the paint edger of the present invention in open position.

FIG. 3 is a bottom plan view of the applicator pads of the paint edger of the present invention in the closed position.

FIG. 4 is a bottom plan view of the applicator pads of the present invention in the open position.

FIG. 5 is a front elevational view showing the applicator pads in the open position.

FIG. 6 is a front elevational view showing the applicator pads in the closed position.

FIG. 7 is a perspective view of the frame.

FIG. 8 is a schematic view showing the separator guide blade of the present invention.

FIG. 9 is a partial view broken away showing the underside of the handle of the present invention.

FIG. 10 is a rear view of a first embodiment of an extension pole mount for the paint edger of the present invention.

FIG. 11 is a top view of the extension pole mount of FIG. 10 with the extension pole coupling in position and assembled.

FIG. 12 is a side view of the extension pole coupling of FIG. 11.

FIG. 13 is a rear view of a second embodiment of an extension pole mount for the paint edger of the present invention.

FIG. 14 is a side view of the extension pole swivel coupling shown in FIG. 13.

### DETAILED DESCRIPTION OF THE INVENTION

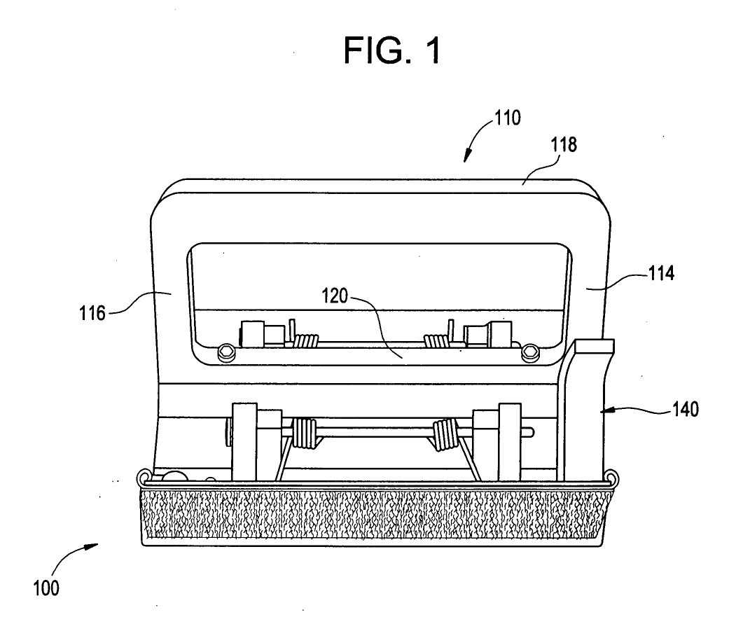

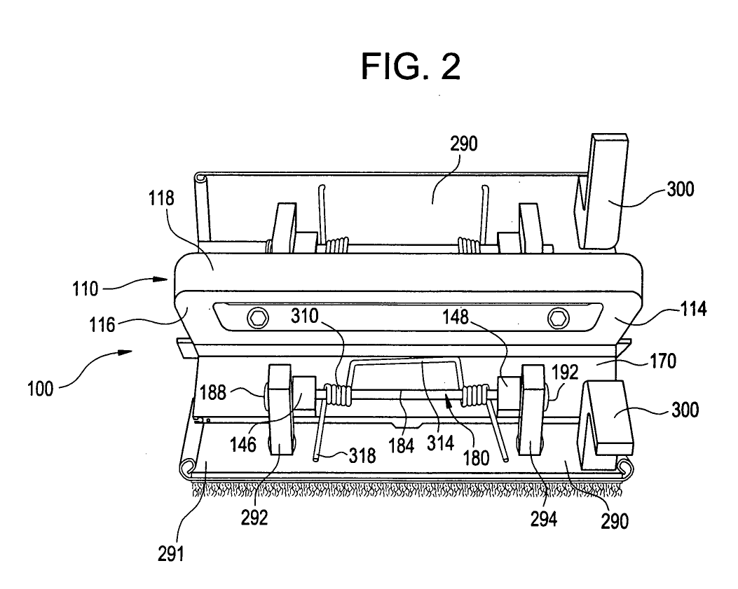

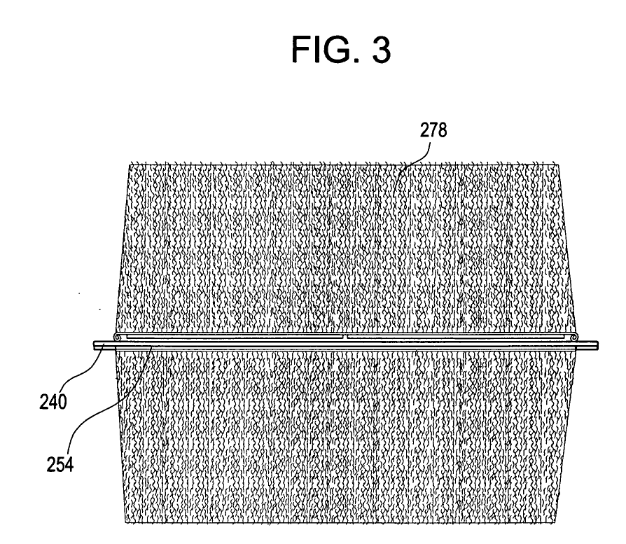

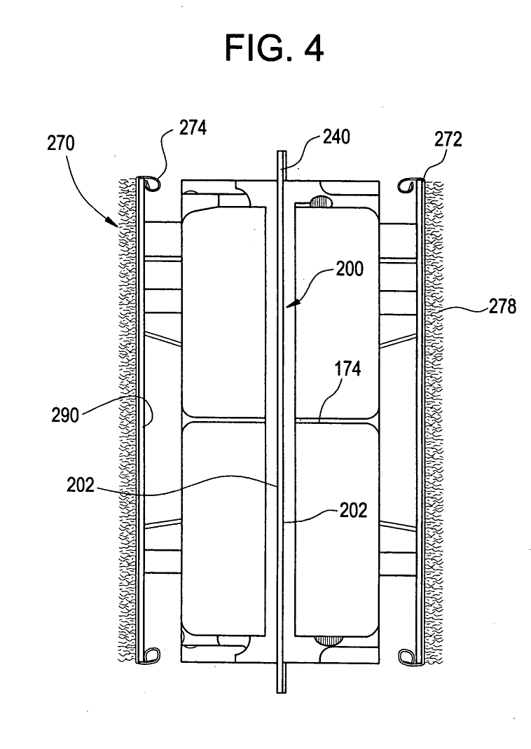

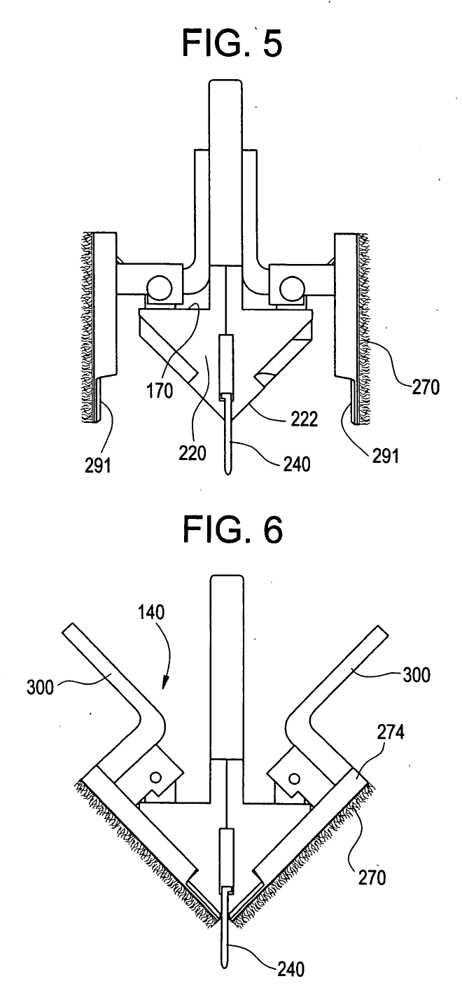

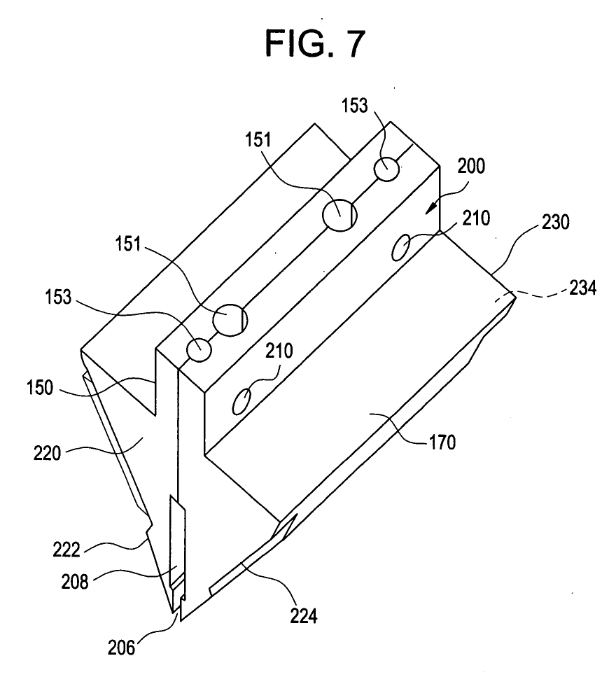

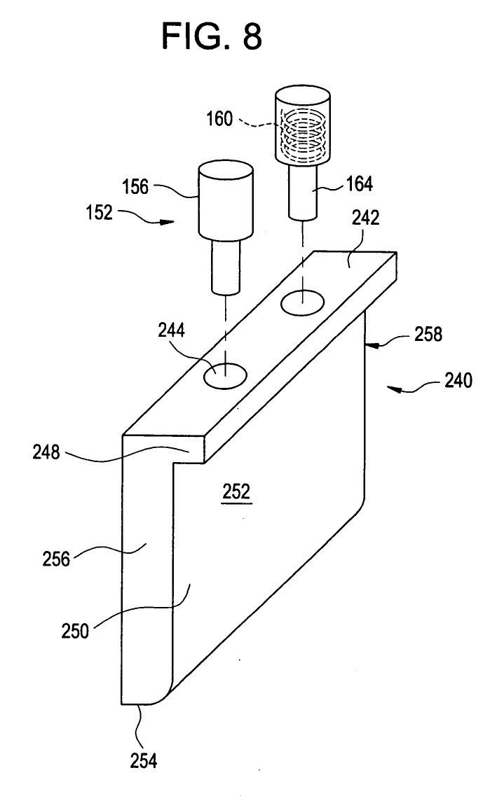

As shown in FIGS. 1-14, the edging apparatus generally indicated at 100 has a handle 110 with two posts 114 and 116 extending upward and a grip 118 to be grasped by the user. Referring to FIG. 1, the bottom of the handle 110 is formed into a bottom flange 120 having a bottom surface 122. There are recesses 124 and 126 in the bottom surface 122 of the handle 112 which are used to receive the top of the spring housing 156, as described in detail below. Passages 128 and 120 in the bottom flange 120 are used for fasteners which connect the handle 110 to the frame 140.

The frame 140 has a head 150, shoulders 170, and a spine 200. In discussing the frame it should be understood that the frame is divided into two halves which are mirror images of each other. The following discussion of one of the frame halves is applicable to that half as well as its mirror image. Similar reference numerals correspond to similar parts in the mirror image portion of the frame. The frame shoulder 170 includes posts 146 front and rear for coaction with posts 292 on applicator plate 290. Passages 148 in posts 146 and passages 294 in posts 292 cooperate with pivot pins 180. Pivot pins 180 have a shaft 184 connected to a head 188 and a cotter pin passage 192 at the other end of the shaft 184 to hold the pivot pin 180 in coactive disposition with the posts 146 of the frame 140 and posts 292 of the plate 290 to allow pivoting of the applicator plates 290 about the frame post 146. A torsion spring 310 wrapped around the pivot pin 180 has an element 314 which contacts the frame 140 and an element 318 which contacts the applicator plate 290 to urge the plate 290 to a closed position against the frame 140.

The frame has a head 150 which has passages 151 for spring units 152 that will be used to contact the separator guide blade 240 and urge it to the outward position. The spring units 152 have a housing 156 for a helical compression spring 160 which urges a plunger 146 downward into the passage 151 to contact the recess 244 in the blade head 242 as will be further described below.

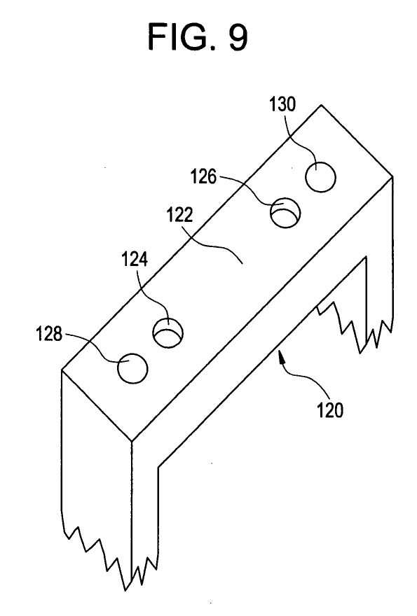

Referring to FIG. 9, the frame 140 has a spine 200 extending down from the shoulder 170. The bottom of the spine 200 has a contact surface 202 for the plate 290 and the spine has a front 220 and a rear 230. The front 220 of the spine 200 has a contact surface 222 for contacting the inner portion 291 of the applicator plate 290 and has a recess 224 for the mounting curl 274 of the applicator pad 270. The front and the rear of the spine 200 can also be considered as the front and rear of the frame. The two halves of the frame 140 are joined together by fasteners that pass through passages 210 which fasteners hold the two halves of the spine together. The spine 200 has a guide slot 206 located at the very bottom of the spine for the contact end 254 of the separator guide blade 240.

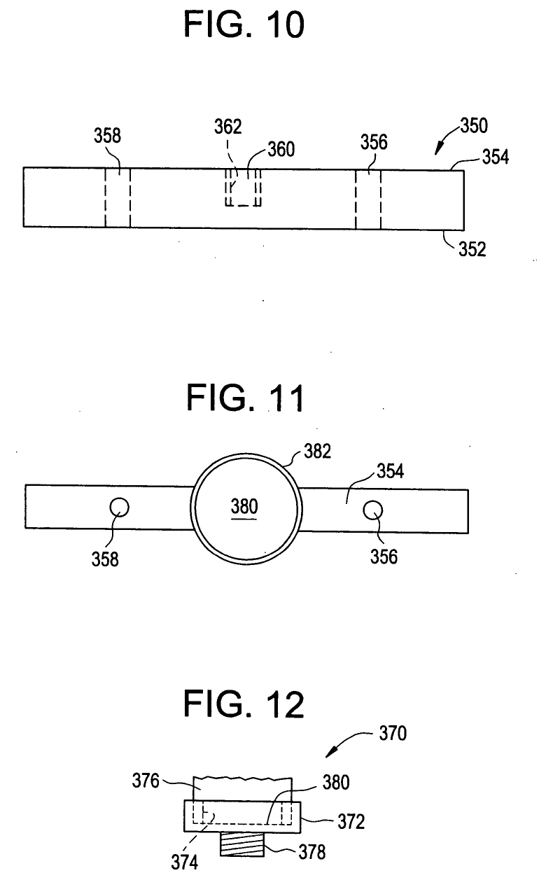

The separator guide blade 240 comprises a blade head 242 having recesses 244 to coact with the end of plunger 164 to position the blade 240 with respect to movement perpendicular to the depth of the guide slot 206 and hold the blade 240 in position relative to the front and back of the apparatus. The blade head 242 has a lip 248 which extends perpendicular to the flat surface 252 of the blade body 250. The lip is large enough so as to capture the blade within the enlarged slot 208 in the frame 140 which allows travel of the lip 248 and head 242 which is much larger than the guide slot 206 and thereby captures the blade 240. The blade 240 is resiliently urged downward by pressures of the plungers on the blade head 242. When the contact end 254 of the blade 240 is pressed against the line of intersection, it will compress the plungers 164, and allow the applicator pads 270 to move down on the intersecting surfaces until almost contacting each other, being separated only by the width of the separator guide blade 240. The blade 240 will prevent any spillage or crossover from one surface to the other as it moves down the line of intersection of the surfaces. Referring to FIG. 10, the body 250 of the blade 240 has a front 256 and a rear 258, which extend slightly beyond the front 220 and rear 230 of the frame 140 of the edging apparatus.

The applicator pads 270 are comprised of a backing member 272 which has mounting curls 274 on its ends, and has an applicator nap 278 on the backing which is used for loading the paint and applying the paint to surfaces. The mounting curls of the applicator pads coact with the ends of applicator plate 290 and slide easily on the edges of the plate 290 and can be removed by grasping the mounting curls 274 and sliding them off the plate 290 without having to come in contact with the applicator nap 278. The applicator pads are easily replaceable and have a standard design.

The applicator plate 290 has L shaped fingers 300 which are intended to be grasped by the thumb and the forefinger of the person using the paint edger as he grasps the grip 118 of the handle 110. By squeezing the fingers 300 of the applicator plates 290 together against the bias of the torsion spring 310, via the action of the contact section 318 of the torsion spring against the plate, the plates will be drawn into a parallel position with each other rather than the 90 degree position. This will space the plates from the separator guide blade 240 to allow the pads to be dipped into the applicable paint reservoirs for loading the applicator pads without the danger of contaminating the other pad or any other part of the apparatus. Optionally, a clip can be provided (not shown) which would hold the fingers 300 of the applicator plates 290 together to maintain the pads 270 in the parallel position while the device is not in use. The front 220 and rear 230 of the frame 140 have recesses 224 in the front and 234 in the rear which will accommodate the mounting curls 278 of the applicator pads 270, while allowing the applicator pads 270 to contact the contact surface 222 of the front 220 of the frame and the contact surface 232 of the rear 230 of the frame to ensure that the applicator pads are in the proper 90 degree position for painting at dissecting surfaces.

The paint edger of the present invention can be used with extension poles to reach inaccessible locations. FIGS. 10-12 show a first embodiment for an extension pole mount for the paint edger. The handle 110 of the edger 100 is removed and replaced with an extension pole mount, generally indicated at 350, having a bottom surface 352 that abuts the top of the spine 200 and has mounting holes 356 and 358 for being secured to the spine 200. The extension pole mount 350 has a top surface 354 in which is formed a threaded bore or socket receptacle 360 having internal threads 362 to receive a coupling, indicated generally at 370, for the extension pole, the bottom of which is shown at 376. The coupling 370 has a threaded plug 378 which engages the internal threads 362 of the threaded bores 360 in the extension pole mount 350, and has a socket 372 with walls 382 in which are formed an internal threaded bore 374. The bottom of extension pole 376 is threaded into the internal threads 374 of the socket 372 and the socket plug 378 is threaded into the threaded bore or socket receptacle 360.

Therefore, much like with standard rollers, the paint edger can be moved along the intersection of wall and ceiling or other areas that are not normally accessible without a ladder.

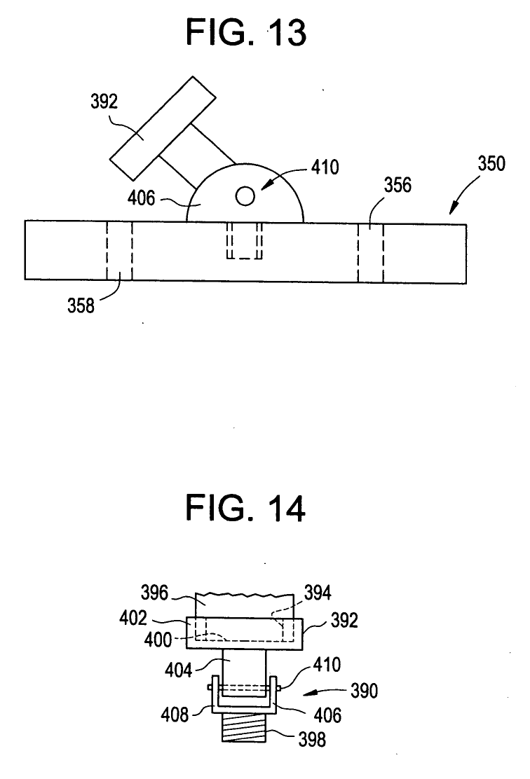

FIGS. 13 and 14 show a second embodiment of the extension pole mount. In this case, the device has a swivel arrangement to allow for more flexibility in the use of the paint edger in inaccessible places.

As shown in FIGS. 13 and 14, the swivel extension pole coupling, generally indicated at 390, has a socket 392 with internally threaded walls 394 and a bottom surface 400 intended to receive in threaded engagement an extension pole, the bottom of which is shown at 396. The socket has a bottom 400. A base 404 extending from the bottom of socket 400 is pivotally connected to pivot arms 406,408 of the base of the socket 404. Pivot arms 406,408 pivot about pivot pin 410.

The coupling 390 could be formed as a fixed unit connected to the extension pole mount 350 rather than in a separate piece threadably engaged as shown here. As seen in FIG. 13, the socket 392 is free to pivot in an arc from the side of the extension pole mount 350 where the mounting hole 358 is located to the side where the other mounting hole 356 is located.

It is possible that a universal coupling could be substituted for the swivel coupling 390 to give even greater degrees of freedom of movement.

It will be understood that the embodiments described herein are merely exemplary and that a person skilled in the art may make many variations and modifications without departing from the spirit and scope of the invention. For example, the invention is not intended to be strictly limited to the named ingredients, temperatures, or other parameters. Rather, the invention as claimed extends to many possible variations not specifically detailed. All such variations and modifications are intended to be included in the scope of the invention as described herein.

1. An edging apparatus comprising
a frame;
a guide slot in said frame;
a separator guide blade movably mounted in said guide slot, said separator guide blade having a contact end;
spring units connected to said frame and contacting said separator guide blade to resiliently urge said separator guide blade from a first retracted position to a second extended position with the contact end extended from the guide slot;
two applicator plates;
a pivot connection mounted on each side of the frame and on each of the applicator plates to pivotally mount said applicator plates on said frame;
a spring in each of said pivot connections to urge the applicator plate from a closed position abutting the separator guide blade to an open position remote from said separator guide blade;
an applicator pad mounted on each applicator plate;
a handle for positioning the edging apparatus;
fasteners connecting said handle to said frame;
actuating fingers on each of said applicator plates constructed to be manipulated to pivotally move said applicator plates and applicator pads mounted thereon from a closed position abutting said separator guide blade to an open position remote from said separator guide blade.

2. An edging apparatus comprising
a handle;
a frame;
a separator guide blade extending from said frame;
at least one applicator pad adapted to apply a coating to a surface pivotally mounted on said frame;
actuator means connected to said at least one applicator pad to move said at least one applicator pad from a closed position abutting said separator guide blade to an open position remote from said separator guide blade,
wherein in the open position, said at least one applicator pad can be loaded with a coating to be applied to a surface.

3. The edging apparatus of claim 2 wherein said actuator means comprises
applicator plates,
finger means extending from said applicator plates,
spring means connecting said applicator plates and said frame,
said applicator pads mounted on said applicator plates.

4. The edging apparatus of claim 2 wherein said frame has a guide slot for said separator guide blade and springs disposed in said frame contact said separator guide blade to urge said guide blade outward from said frame.

5. The edging apparatus of claim 3 wherein said frame comprises posts for holding pivot pins on which the applicator plates are pivotally mounted and a resilient spring to urge the applicator plates into the closed position abutting the separator guide blade.

6. The edging apparatus of claim 2 wherein said handle is removably connected to said frame.

7. The edging apparatus of claim 6 wherein said handle includes an extension coupling for connecting the frame to an extension pole.

8. The edging apparatus of claim 7 wherein the extension coupling includes pivot means to allow for pivotal movement of the frame with respect to the extension pole.

9. A method of applying a surface coating to a surface comprising the steps of
a. providing an edging apparatus having at least one applicator pad mounted to a frame which frame includes a separator guide blade having a contact end;
b. pivoting said at least one applicator pad to a position remote from said separator guide blade;
c. applying a coating material to said applicator pad;
d. pivotally moving said at least one applicator pad to a position abutting said separator guide blade; and
e. placing the contact end of said separator guide blade against a surface to bring said applicator pad into contact with the surface while the separator guide blade prevents contact of the coating on the applicator pad with the other side of the separator guide blade.

10. A method of applying a surface coating to two intersecting surfaces comprising the steps of
a. providing an edging apparatus having first and second applicator plates mounted to a frame which includes a resiliently mounted separator guide blade having a contact end, said first and second applicator plates in opposed relationship to said separator guide blade;
b. installing a first applicator pad on said first applicator plate and a second applicator pad on said second applicator plate;
c. pivoting said first and second applicator plates to a position remote from said separator guide blade;
d. applying a coating material to said first and second applicator pads on said first and second applicator plates;
e. pivotally moving said first and second applicator plates to a position abutting said separator guide blade;
f. resiliently urging the contact end of the separator guide blade into the intersection of two surfaces to bring at least one of said first and second applicator pads into contact with one of the surfaces while the separator guide blade prevents contact of the coating on the other one of said first and second applicator pads with the other of the intersecting surfaces, and
g. resiliently urging said first and second applicator plates into contact with the separator guide blade.

11. The method of claim 10 wherein a different coating is applied to each one of the first and second applicator pads.
